(19) United States
(12) Patent Application Publication
(10) Pub. No.: US 2017/0044710 A1
(43) Pub. Date: Feb. 16, 2017

(54) SURFACE-TREATED FABRICATED ARTICLE PRODUCED FROM POLYOLEFIN

(71) Applicant: Dow Global Technologies LLC, Midland, MI (US)

(72) Inventors: Bryan E. Barton, Newark, DE (US); Eric J. Hukkanen, Midland, MI (US)

(21) Appl. No.: 15/304,690

(22) PCT Filed: Apr. 15, 2015
(86) PCT No.: PCT/US2015/025925

§ 371 Date: Oct. 17, 2016

Related U.S. Application Data
(60) Provisional application No. 61/982,115, filed on Apr. 21, 2014.

(51) Int. Cl. D06M 11/55; C08J 7/14; D01F 9/21; C08J 3/24

(52) U.S. Cl. CPC D06M 11/55; C08J 3/24; C08J 7/14; D01F 9/21; C08J 2323/32

(57) ABSTRACT

The present disclosure describes a process for producing a surface-treated fabricated article, the process comprising providing a polyolefin resin; converting the polyolefin resin to a fabricated article; crosslinking at least a portion of the fabricated article; and modifying the surface of the fabricated article with a sulfuric acid, fuming sulfuric acid, or chlorosulfonic acid-containing solution surface-treating agent to yield the surface-treated fabricated article. The present disclosure further describes a process for producing a surface-treated fabricated article comprising providing a polyolefin resin; converting the polyolefin resin to a fabricated article; crosslinking at least a portion of the fabricated article; applying a sulfuric acid solution to the fabricated article; and heating the fabricated article in air or an inert environment.

### STATEMENT OF GOVERNMENT INTEREST

This invention was made under a NFE-10-02991 between The Dow Chemical Company and UT-Battelle, LLC, operating and management Contractor for the Oak Ridge National Laboratory operated for the United States Department of Energy. The Government has certain rights in this invention.

### FIELD

The present disclosure relates generally to a surface-treated fabricated article produced from polyolefin and the process of making the same, and further relates to a carbonaceous article and a process for making the same from the surface-treated fabricated article.

### BACKGROUND

Previously, carbonaceous articles, such as carbon fibers, have been primarily produced from polyacrylonitrile (PAN), pitch, or cellulose precursors. The process for making such carbonaceous articles begins by forming a fabricated article, such as a fiber or a film, from the precursor. Precursors may be formed into fabricated articles using standard techniques for forming or molding polymers. The fabricated article is subsequently stabilized to allow the fabricated article to substantially retain shape during the subsequent heat-processing steps; such stabilization typically involves a combination of oxidation and heat and generally results in dehydrogenation, ring formation, oxidation and crosslinking of the precursor which defines the fabricated article. The stabilized fabricated article is then converted into a carbonaceous article by heating the stabilized fabricated article in an inert atmosphere. While the general steps for producing a carbonaceous article are the same for the variety of precursors, the details of those steps vary widely depending on the chemical makeup of the selected precursor.

Polyolefins have been investigated as an alternative precursor for carbonaceous articles, but a suitable and economically viable preparation process has proven elusive.

One process for transforming a polyolefin fabricated article to a stabilized polyolefin fabricated article involves heating the polyolefin fabricated article in an oxidizing atmosphere, most typically at temperatures above the melting point of polyolefins, commonly above 160° C. Standard polyolefins will melt at these temperatures, and lose their fabricated dimensions (i.e., the fibers will melt into a liquid). Crosslinking has been pursued as a means to stabilize the fabricated polyolefin article's dimensions at temperatures above the polyolefin's melting point, and although the crystallites present in crosslinked polyolefins still melt, the article retains its shape. One failing of previous attempts to form carbon fibers from crosslinked polyolefin fabricated articles is that as the crosslinked fabricated articles are heated, the filaments which form the fiber fuse together. Without being limited by theory, when a crosslinked polyolefin fabricated article is heated, some polymer chains can become sufficiently mobile at the surface of the fiber and thereby undergo molecular entanglement with the polymer chains from an adjacent fiber resulting in the appearance of sticky surfaces or filament fusion. The resulting filament fusion resulting from the oxidation step is carried through to the carbonized article. In some instances, fusion diminishes the structural properties of the carbonaceous article.

U.S. Pat. No. 4,070,446 discloses a sulfonation process for treating non-crosslinked polyethylene fibers, where the polyethylene fibers are reacted with sulfuric acid at a temperature of 100° C.-180° C. to form a stabilized precursor to carbon fiber. The process described therein does not involve heating the polyethylene fibers in air. Further, the process is not economical due to the large volume of sulfuric acid required.

A precursor for carbonaceous articles produced from a polyolefin resin is desired which does not deform, or fuse during the processing steps.

### STATEMENT OF INVENTION

The present disclosure describes a process for producing a surface-treated fabricated article, the process comprising providing a polyolefin resin; converting the polyolefin resin to a fabricated article; crosslinking at least a portion of the fabricated article; and modifying the surface of the fabricated article with a sulfuric acid, fuming sulfuric acid, or chlorosulfonic acid-containing solution surface-treating agent to yield the surface-treated fabricated article.

The present disclosure further describes a process for producing a surface-treated fabricated article comprising providing a polyolefin resin; converting the polyolefin resin to a fabricated article; crosslinking at least a portion of the fabricated article; applying a sulfuric acid solution to the fabricated article; and heating the fabricated article in air or an inert environment.

### DETAILED DESCRIPTION

Unless otherwise indicated, numeric ranges, for instance “from 2 to 10,” are inclusive of the numbers defining the range (e.g., 2 and 10).

Unless otherwise indicated, ratios, percentages, parts, and the like are by weight.

Unless otherwise indicated, the crosslinkable functional group content for a polyolefin resin is characterized by the mol % crosslinkable functional groups, which is calculated as the number of mols of crosslinkable functional groups divided by the total number of mols of monomer units contained in the polyolefin.

Unless otherwise indicated, “monomer” refers to a molecule which can undergo polymerization, thereby contributing constitutional units to the essential structure of a macromolecule, for example, a polyolefin.

As noted above, in one aspect, the present disclosure describes a process for producing a surface-treated fabricated article from a polyolefin resin. Polyolefins are a class of polymers produced from one or more olefin monomer. The polymers described herein may be formed from one or more types of monomers. Polyethylene is the preferred polyolefin resin, but other polyolefin resins may be substituted. For example, a polyolefin produced from ethylene, propylene, or other alpha-olefin (for instance, 1-butene, 1-hexene, 1-octene), or a combination thereof, is also suitable. The polyolefins described herein are typically provided in resin form, subdivided into pellets or granules of a convenient size for further melt or solution processing.

The polyolefin resins described herein are suitable for crosslinking. In one instance, the polyolefin reins have been modified to include crosslinkable functional groups which are suitable for reacting to crosslink the polyolefin resin. In some embodiments, the polyolefin resin having crosslinkable functional groups contains at least 0.1 mol % crosslinkable functional groups. In some embodiments, the polyolefin resin having crosslinkable functional groups contains at least one crosslinkable functional group per polymer chain. In some embodiments, the polyolefin resin having crosslinkable functional groups contains up to 0.5 mol % crosslinkable functional groups, preferably, up to 1.0 mol % crosslinkable functional groups, more preferably up to 5.0 mol % crosslinkable functional groups. In some embodiments, the polyolefin resin may include as much as 50 mol % of crosslinkable functional groups depending on the monomer selected to form the polyolefin resin. In some embodiments, the polyolefin resin having crosslinkable functional groups has a bulk density of at least 0.87 g/cm³. In some embodiments, the polyolefin resin having crosslinkable functional groups has a bulk density of no more than 0.955 g/cm³. The crosslinkable functional groups are incorporated in the polyolefin resin according to known mechanisms, for example, ethylene can be copolymerized with vinyl functional comonomers containing the desired crosslinkable functional group, or a related chemical moiety which is a precursor to the desired crosslinkable functional group, to provide the desired polyolefin resin having crosslinkable functional groups. Copolymers are suitable for use as the polyolefin resin having crosslinkable functional groups where one or more alpha-olefins have been copolymerized with another monomer containing a group suitable for serving as a crosslinkable functional group, for example, dienes, carbon monoxide, glycidyl methacrylate, acrylic acid, vinyl acetate, maleic anhydride, or vinyl trimethoxy silane (VTMS) are among the monomers suitable for being copolymerized with the alpha-olefin. Further, the polyolefin resin having crosslinkable functional groups may also be produced from a poly(alpha-olefin) which has been modified by grafting a functional group moiety onto the base polyolefin, wherein the functional group is selected based on its ability to subsequently enable crosslinking of the given polyolefin. For example, grafting of this type may be carried out by use of free radical initiators (such as peroxides) and vinyl monomers (such as VTMS, dienes, vinyl acetate, acrylic acid, methacrylic acid, acrylic and methacrylic esters such as glycidyl methacrylate and methacryloxypropyl, trimethoxysilane, allyl amine, p-aminostyrene, dimethylaminoethyl methacrylate) or via azido-functionalized molecules (such as 4-[2-(trimethoxysilyl)ethyl)]benzenesulfonyl azide). Polyolefin resins having crosslinkable functional groups may be produced from a polyolefin resin, or may be purchased commercially. Examples of commercially available polyolefin resins having crosslinkable functional groups include SI-LINK sold by The Dow Chemical Company, PRIMACOR sold by The Dow Chemical Company, EVAL resins sold by Kuraray, and LOTADER AX8840 sold by Arkema. In one instance, the polyolefin resin is crosslinked by irradiation. In one instance, the irradiation is performed by electron beam processing or electron irradiation (e-beam). Where irradiation is used, crosslinkable functional groups are not necessary (though may be included) in the polyolefin resin.

As described above, the polyolefin resin is processed to form a fabricated article. A fabricated article is an article which has been fabricated from the polyolefin resin having crosslinkable functional groups. The fabricated article is formed using known polyolefin fabrication techniques, for example, melt or solution spinning to form fibers, film extrusion or film casting or a blown film process to form films, die extrusion or injection molding or compression molding to form more complex shapes, or solution casting. The fabrication technique is selected according to the desired geometry of the target carbonaceous article, and the desired physical properties of the same. For example, where the desired carbonaceous article is a carbon fiber, fiber spinning is a suitable fabrication technique. As another example, where the desired carbonaceous article is a carbon film, compression molding is a suitable fabrication technique.

As noted above, at least a portion of the crosslinkable functional groups of the polyolefin resin are crosslinked to yield a crosslinked fabricated article. In some embodiments, crosslinking is carried out via chemical crosslinking. Thus, in some embodiments, the crosslinked fabricated article is a fabricated article which has been treated with one or more chemical agents to crosslink the crosslinkable functional groups of the polyolefin resin having crosslinkable functional groups. Such chemical agent functions to initiate the formation of intramolecular chemical bonds between the crosslinkable functional groups or reacts with the crosslinkable functional groups to form intramolecular chemical bonds. The chemical agent is applied in a way which causes the chemical agent to contact and diffuse into the fabricated article, for example, by immersion. In one instance, following treatment with the chemical agent, the crosslinked fabricated article is dried to remove any process solvents or diluents. In one instance, following drying the fabricated article is heated in air or an inert atmosphere or a reduced pressure atmosphere to initiate and carry out the desired crosslinking reaction. In another instance, the crosslinking reaction is initiated by submersing the fabricated article in an inert fluid at a desired temperature or by placing the fabricated article in contact with a heated surface. For example, after exposure to the chemical agent, the fabricated article may be heated in air at 100-150° C. for one hour. In another example, after exposure to the chemical agent, a polyolefin fiber possessing crosslinkable functional groups can be heated by passage over cored, oil-heated rollers to induce crosslinking. In another instance, exposure of the fabricated article to the chemical agent may be combined with heating to cause the crosslinking reaction, such that both steps are accomplished simultaneously in a single process. In yet another instance, the fabricated article is prepared from a polyolefin possessing functional groups that can be crosslinked by steam, whereby the fabricated article is placed in a moisture oven to induce crosslinking, for example, the fabricated article can be placed in a moisture oven at 80° C. for three days.

Chemical crosslinking causes the crosslinkable functional groups to react to form new bonds, forming linkages between the various polymer chains which define the polyolefin resin having crosslinkable functional groups. The chemical agent which effectuates the crosslinking is selected based on the type of crosslinkable functional group(s) included in the polyolefin resin; a diverse array of reactions are known which crosslink crosslinkable functional groups via intermolecular and intramolecular chemical bonds. A suitable chemical agent is selected which is known to crosslink the crosslinkable functional groups present in the fabricated article to produce the crosslinked fabricated article. For example, without limiting the present disclosure, if the crosslinkable functional group attached to the polyolefin is a vinyl group, suitable chemical agents include free radical initiators such as peroxides or nitriles, for example, dicumyl peroxide, dibenzoyl peroxide, t-butyl peroctoate, azobisisobutyronitrile, and the like. If the crosslinkable functional group attached to the polyolefin is an acid, such as a carboxylic acid, or an anhydride, or an ester, or a glycidoxy group, a suitable chemical agent can be a compound containing at least two nucleophilic groups, including dinucleophiles such as diamines, diols, dithiols, for example ethylenediamine, hexamethylenediamine, butane diol, or hexanedithiol. Compounds containing more than two nucleophilic groups, for example glycerol, sorbitol, or hexamethylene tetramine can also be used. Mixed di- or higher-nucleophiles, which contain at least two different nucleophilic groups, for example ethanolamine can also be suitable chemical agents. If the crosslinkable functional group attached to the polyolefin is a mono-, di- or tri-alkoxy silyl group, water, and Lewis or Bronsted acid or base catalysts can be used as suitable chemical agents. For example, without limiting the present disclosure, Lewis or Bronsted acid or base catalysts include aryl sulfonic acids, sulfuric acid, hydroxides, zirconium alkoxides or tin reagents.

Crosslinking the fabricated article is necessary to ensure that the fabricated article retains its shape at the elevated temperatures required for the subsequent processing steps. Without crosslinking, polyolefin resins soften, melt or otherwise deform or breakdown at elevated temperatures. Crosslinking adds thermal stability to the fabricated article.

One advantage of using a chemical agent to perform the crosslinking is that it is possible to crosslink the crosslinkable functional groups throughout the fabricated article. Further, use of a chemical agent produces a fabricated article having a chemical structure which is suitable for being stabilized in air, as described herein. Other crosslinking mechanisms, such as irradiation, cause non-homogenous crosslinking, where some parts of the fabricated article will undergo more crosslinking than other areas of the fabricated article. Further, crosslinking with a chemical agent targets specific crosslinking reactions and allows control over the extent of crosslinking, unlike irradiation which causes a variety of chemical reactions beyond crosslinking. As such, crosslinking as induced by a chemical agent is preferred to irradiation.

As noted above, the surface of the fabricated article is modified with a surface-treating agent to yield a surface-treated fabricated article. The surface of the fabricated article is defined as the outermost portion of the fabricated article. The surface-treating agent is a chemical agent which is suitable for pacifying the surface of the fabricated article. The surface of the fabricated article is pacified when adjacent fabricated articles do not fuse together when heated, such as during the air-oxidation process described herein. In some embodiments, the surface of the fabricated article is pacified when adjacent fabricated articles are substantially not fused together when heated. In some embodiments, the surface-treating agent is an SO₃ containing moiety. In some embodiments, the surface-treating agent is selected from the list consisting of sulfuric acid, fuming sulfuric acid, sulfur trioxide, and chlorosulfonic acid. Without being limited by theory, the surface-treating agent serves to prevent the fabricated article from fusing together when heated by pacifying the surface of the fabricated article. For example, where the fabricated article is a fiber, if the fabricated article is not treated with the surface-treating agent, the filaments which comprise the fiber will fuse together when heated. Treating the fiber with the surface-treating agent helps to prevent filament fusion. In one instance, the concentration of the sulfuric acid in the surface-treating agent is 90 percent or less. In one instance, the concentration of the sulfuric acid in the surface-treating agent is 10 percent or less.

In one instance, the crosslinking step and the surface-treatment step are performed simultaneously by selecting a compound which performs the functions of both the chemical agent and the surface-treating agent. For example, SO₃ containing moieties are suitable for both crosslinking and surface treating a polyolefin fabricated article. In some embodiments, chemical crosslinking and surface treating of the fabricated article are performed in a single step by treating the fabricated article with an SO₃ containing moiety. In some embodiments, the conditions for this single-step treatment include treating the fabricated article with the surface-treating agent and heating the fabricated article step-wise, for example, heating at 60° C. for 20 minutes, followed by heating at 80° C. for 20 minutes, followed by heating at 100° C. for 20 minutes. In some embodiments, the fabricated article is then washed with water. In some embodiments, the fabricated article is first crosslinked, and is second surface-treated.

In one instance, following surface treatment, the surface-treated fabricated article is washed in a solvent. Suitable solvents may include toluene, xylene, or a high-temperature halocarbon. An example of a suitable high-temperature halocarbon is tetracholorethane. In some embodiments, the temperature of the solvent is above room temperature. In one instance, the temperature of the solvent is at or is greater than 80° C. In another instance, the temperature of the solvent is at or is less than 100° C. Without being limited by theory, washing the surface-treated fabricated article with the solvent removes at least some of the portions of the fabricated article which were not crosslinked. It was observed that washing with the solvent reduces the instances of filament fusion. It is anticipated that where the crosslinking step is more efficient, meaning a greater percentage of the fabricated article is crosslinked, the need to wash with the solvent will be reduced. It is anticipated that washing with the solvent will be unnecessary where there is extensive crosslinking in the fabricated article. For example, where the fabricated article is 80-100% crosslinked, the solvent wash step may be unnecessary.

In another aspect, the present disclosure describes a surface-treated fabricated article which is formed from a polyolefin precursor. In one instance, the surface-treated fabricated article is formed according to the process described herein.

As described above, the surface-treated fabricated article is heated in an oxidizing environment to yield a stabilized fabricated article. It is preferred that the oxidizing environment is continuously charged to the oven or other apparatus in which the stabilization process is executed to prevent depletion of the oxidizing agent and accumulation of by-products. The stabilized fabricated article is a surface-treated fabricated article which has been heat-treated in an oxidizing environment. Preferably, the surface-treated fabricated article is stabilized in flowing air at a temperature at or above 160° C. In some embodiments, the temperature for stabilizing the surface-treated fabricated article is at least 120° C., preferably at least 190° C. In some embodiments, the temperature for stabilizing the surface-treated fabricated article is no more than 400° C., preferably no more than 300° C. In one instance, the surface-treated fabricated article is introduced to a heating chamber which is already at the desired temperature. In another instance, the fabricated article is introduced to a heating chamber at or near ambient temperature, which chamber is subsequently heated to the desired temperature. In some embodiments the heating rate is at least 1° C./minute. In other embodiments the heating rate is no more than 15° C./minute. In yet another instance, the chamber is heated step wise, for instance, the chamber is heated to a first temperature for a time, such as, 120° C. for one hour, then is raised to a second temperature for a time, such as 180° C. for one hour, and third is raised to a holding temperature, such as 240° C. for 12 hours. The stabilization process involves holding the surface-treated fabricated article at the given temperature for periods up to 100 hours depending on the dimensions of the fabricated article. The stabilization process yields a stabilized fabricated article which is a precursor for a carbonaceous article. Without being limited by theory, the stabilization process oxidizes the surface-treated fabricated article and causes changes to the hydrocarbon structure that increases the crosslink density while decreasing the hydrogen/carbon ratio of the crosslinked fabricated article.

Unexpectedly, it has been found that heated air at the normal oxygen content of approximately 21 percent by volume is a suitable oxidizing environment. Previous stabilization techniques have involved the use of large quantities of sulfuric acid, or other chemicals, to oxidize the crosslinked fabricated article. By using air as the oxidizing agent, the cost to prepare the stabilized fabricated article is greatly reduced. It is unexpected to find that a polyolefin-based fabricated article, which was chemically crosslinked, can be stabilized by holding in an oxidizing atmosphere for a period of time.

In another aspect, the present disclosure describes a stabilized fabricated article which is formed from a polyolefin precursor and a process for making the stabilized fabricated article. In one instance, the stabilized fabricated article and its process are carried out as described herein. For instance, the process comprises: (a) providing a polyolefin resin having crosslinkable functional groups; (b) converting the polyolefin resin to a fabricated article; (c) crosslinking at least a portion of the crosslinkable functional groups; (d) modifying the surface of the fabricated article with a surface-treating agent to yield the surface-treated fabricated article; and (e) heating the surface-treated fabricated article in an oxidizing environment to yield a stabilized fabricated article.

In one instance, the present disclosure describes a process for producing a surface-treated fabricated article comprising providing a polyolefin resin; converting the polyolefin resin to a fabricated article; crosslinking at least a portion of the fabricated article; applying a sulfuric acid solution to the fabricated article; and heating the fabricated article in air or an inert environment. In one instance, the air or the inert environment is passed over the fabricated article, such as by convection. Without being limited by theory, it is expected that the convective environment evaporates a portion of the water from the sulfuric acid solution to concentrate the sulfuric acid to aid in the stabilization process.

In yet another aspect, a process is provided for producing a carbonaceous article. Carbonaceous articles are articles which are rich in carbon; carbon fibers, carbon sheets and carbon films are examples of carbonaceous articles. Carbonaceous articles have many applications, for example, carbon fibers are commonly used to reinforce composite materials, such as in carbon reinforced epoxy composite, while carbon discs or pads are used for high performance braking systems.

The carbonaceous articles described herein are prepared by heat-treating the stabilized fabricated articles in an inert environment. The inert environment is an environment surrounding the stabilized fabricated article that shows little reactivity with carbon at elevated temperatures, preferably a high vacuum or an oxygen-depleted atmosphere, more preferably a nitrogen atmosphere or an argon atmosphere. It is desirable to remove volatile by-products from the inert environment by continuous application of vacuum or by continuously flowing the inert atmosphere through the furnace or other apparatus in which the carbonization process is executed in order to prevent accumulation of such by-products in the inert environment. It is understood that trace amounts of oxygen may be present in the inert atmosphere. In one instance, the temperature of the inert environment is at or above 600° C. Preferably, the temperature of the inert environment is at or above 800° C. In one instance, the temperature of the inert environment is no more than 3000° C. Temperatures at or near the upper end of that range will produced a graphite article, while temperatures at or near the lower end of the range will produce a carbon article.

In order to prevent bubbling or damage to the fabricated article during carbonization, it is preferred to heat the inert environment in a gradual or stepwise fashion. In one embodiment, the stabilized fabricated article is introduced to a heating chamber containing an inert environment at or near ambient temperature, which chamber is subsequently heated over a period of time to achieve the desired final temperature. In some embodiments, the heating rate is at least 1° C./minute. In other embodiments the heating rate is no more than 15° C./minute. The heating schedule can also include one or more hold steps for a prescribed period at the final temperature or an intermediate temperature or a programmed cooling rate before the article is removed from the chamber.

In yet another embodiment, the chamber containing the inert environment is subdivided into multiple zones, each maintained at a desired temperature by an appropriate control device, and the stabilized fabricated article is heated in a stepwise fashion by passage from one zone to the next via an appropriate transport mechanism, such as a motorized belt. In the instance where a stabilized fabricated article is a fiber, this transport mechanism can be the application of a traction force to the fiber at the exit of the carbonization process while the tension in the stabilized fiber is controlled at the inlet.

Advantageously, it has been found that this process for producing a carbonaceous article is preferred to prior processes because polyolefin is more economical than previous precursors, because crosslinking with a chemical agent is more economical and produces a more desirable chemical structure than crosslinking by irradiation, because surface-treatment prevents fusion, and because air oxidation is more economical than previously reported stabilization methods for polyolefins. In sum, the present process is a significant improvement over previous processes.

In another aspect, the present disclosure describes a carbonaceous article which is formed from a polyolefin precursor. In one instance, the carbonaceous article is formed according to the process described herein.

In the preferred embodiment, the chemical makeup of the resulting surface treated fabricated articles, stabilized fabricated articles, or carbonaceous articles will be uniform throughout the respective fabricated article. In another embodiment, it is envisioned that the chemical makeup of the respective fabricated article will be non-uniform, or will have a gradient.

Some embodiments of the invention will now be described in detail in the following Examples.

In the Examples, the TGA method refers to placing a sample of the fabricated article in a TA Instruments Thermal Gravimetric Analyzer (TGA) Q500 which is heated at 10° C./min to 800° C. in a nitrogen atmosphere. The TGA uses the weight following heating to calculate the char yield. In some embodiments, the char yield is at or above 0.3%. In some embodiments, the char yield is at or below 30%. In one instance, the char yield is 10% or less. In one instance, the char yield is 0.2% to 30%. The char yield is used herein to approximate the extent of sulfonation.

In the Examples, Soxhlet extraction refers to a method for determining the gel content and swell ration of crosslinked ethylene plastics. As used herein, Soxhlet extraction is conducted according to ASTM Standard D2765-11 “Standard Test Methods for Determination of Gel Content and Swell Ratio of Crosslinked Ethylene Plastics.” In the method employed, a crosslinked fabricated article between 0.050-0.500 g is weighed and placed into a cellulose-based thimble which is then placed into a soxhlet extraction apparatus with sufficient quantity of xylenes. Soxhlet extraction is then performed with refluxing xylenes for at least 12 hours. Following extraction, the thimbles are removed and the crosslinked fabricated article is dried in a vacuum oven at 80° C. for at least 12 hours and then weighed, thereby providing a Soxhlet-treated article. The gel content (%) is then calculated from the weight ratio (Soxhlet-treated article)/(crosslinked fabricated article). In one instance, the gel content of the surface-treated article is 40 percent or greater. The gel content is a function of molecular weight, in most instances, the gel content will be no greater than 99 percent.

### Example 1A

A copolymer resin of ethylene and VTMS (melt index=1.5%, density=0.922 g/cm3, VTMS content=42%) was formed into a fabricated article by melt spinning with a Hills Inc. spin line at 285° C. through a 143 hole die with 350 micron orifice. The resulting fabricated article was fiber-shaped, which fibers were approximately 200 microns in diameter.

### Example 1B

A fiber prepared in Example 1A was coated with 97.5% sulfuric acid and heated to 60° C., held for 20 minutes, heated to 80° C., held for 20 minutes, and heated to 100° C., held for 20 minutes. After the 100° C. hold, the fiber appeared grey in color. The fiber was washed in water. The fiber was then heated in air at 220° C. overnight. Following heating, the fibers appeared dark brown in color and showed no signs of filament fusion.

### Comparative Example 1B

A fiber prepared in Example 1A was heated in air at 190° C. overnight. Following heating, the fibers appeared black in color and the filaments were fused together.

### Example 2A

A copolymer resin of ethylene and 1-octene (melt index=30, density−0.900 g/cm³, crystallinity=16%) was grafted with VTMS with a 25 mm twin screw extruder. The resulting grafted polymer contained 1.23 wt % VTMS as determined by Neutron Activation Analysis. The grafted polymer was then melt spun with a Hills Inc. spin line at 210° C. through a 143 hole die with 350 micron orifice. The resulting fibers were then combined with a denier tester to yield a 1573 filament tow, 1 meter in length. This two was then treated with an aryl sulfonic acid catalyst (B201, sold by King Industries) in isopropanol at room temperature for 10 seconds, followed by treatment in a moisture oven for 5 hours at 60° C. The resulting fabricated article was fiber-shaped, which fibers were approximately 23 microns in diameter.

### Example 2B

A fiber prepared in Example 2A was treated with 6% fuming sulfuric acid at 45° C. for 1 hour in a batch reactor. The resulting fiber was dark brown in color. The char yield, as calculated using the TGA method, was 3.8%.

### Comparative Example 2B 1

A fiber prepared in Example 2A was passed through a 190° C. air oxidation tube furnace for 20 minutes. The fiber did not lose shape. The resulting filaments were fused together.

### Comparative Example 2B 2

A fiber prepared in Example 2A was treated with 6% fuming sulfuric acid at ambient temperature for 1 hour in a batch reactor. The resulting fiber was dark brown in color. The char yield, as calculated using the TGA method, was 1.4%. The fiber was then passed through a 190° C. air oxidation tube furnace for 20 minutes. The resulting filaments showed some filament fusion.

### Example 2C 1

A fiber prepared in Example 2B was treated with toluene at 80° C. for 30 minutes and then dried. Following drying, the fiber was measured as having lost 36% of its mass. The fiber was then passed through a 190° C. air oxidation tube furnace for 20 minutes. The resulting filaments showed little to no filament fusion.

### Example 2C 2

The fiber prepared in Example 2B was treated with toluene at 100° C. for 30 minutes and then dried. Following drying, the fiber was measured as having lost 47% of its mass. The fiber was then passed through a 190° C. air oxidation tube furnace for 20 minutes. The resulting filaments showed little to no filament fusion.

Example 3A

A copolymer resin of ethylene and 1-octene (melt index=35, density−0.941 g/cm³, crystallinity=47%) was grafted with VTMS with a 25 mm twin screw extruder. The reactive extrusion was performed at 200° C. with the polyethylene fed at 35 lb/hour and screw speed set at 350 RPM. The reactive components added were 3 wt % VTMS and 0.0375 wt % 2,5 -dimethyl-2,5 -di(t-butylperoxy)hexane (VTMS:Peroxide=80:1). The resulting grafted polymer contained 2.11 wt % VTMS as determined by Neutron Activation Analysis. The grafted polymer was then melt spun with a Hills Inc. spin line at 210° C. through a 143 hole die with 350 micron orifice producing continuous tows, hundreds of meters in length, wound onto spools. Eleven identical spools were then combined and drawn via winders through ovens maintained at 60-80° C. to yield a tow of 1573 filaments several hundred meters in length, with average diameter of 15 microns.

### Example 3B

The continuous fibers produced in Example 3A were treated continuously through a sulfonation apparatus which includes four baths, as described as follows. The fiber was treated in the first bath with 6% fuming sulfuric acid at 90° C. for 5 minutes. The fiber was then treated in the second bath with 96% sulfuric acid at room temperature for 5 minutes. The fiber was then treated in the third bath with 50% sulfuric acid at room temperature for 5 minutes. The fiber was then treated in the fourth bath with continuously supplied de-ionized water at room temperature for 5 minutes. Baths two, three, and four are employed to remove residual sulfuric acid. Following treatment in the fourth bath, the fiber was then wound onto a bobbin and dried in air. The TGA method provided (char yield)/(unreacted polymer+char yield)=0.25, indicating that approximately 25% of the polymer fiber was stabilized from sulfonation.

### Example 3C

The partially sulfonated fiber produced in Example 3B was passed through a 190° C. oven in air, and maintained in the hot zone for ˜20 min. The resulting fiber showed no signs of filament fusion.

### Example 3D

The partially sulfonated fiber produce in Example 3B was loaded into a small batch oxidation oven with 20 g weight tension and heated to 230° C. in air at a rate of 5° C./minute. Once at temperature, it was held under these conditions for 15 hours with air flow maintained at 0.5 L/minute during this oxidation stage. Following this step, the gas flow was changed to 0.5 L/minute of nitrogen and the oven was heated at a rate of 5° C./minute to 1000° C., and held at this ‘carbonization’ temperature for 1 hour before cooling at a rate of 5° C./minute to room temperature. The sample broke during the carbonization hold. Once removed, the sample was partially fused and brittle. Individual filament tensile testing was achieved with 0.5-inch gauge length specimens. The average of 9 filaments resulted in the following means: diameter=11.9 microns; Young's Modulus=39.5 GPa; Tensile Strength=0.33 GPa; Tensile Strain=0.90%.

### Example 3E

The partially sulfonated fiber produce in Example 3B was loaded into a small batch oxidation oven with 20 g weight tension and heated to 230° C. in air at a rate of 5° C./minute. Once at temperature, it was held under these conditions for 10 hours with air flow maintained at 0.5 L/minute during this oxidation stage. Following this step, the gas flow was changed to 0.5 L/minute of nitrogen and the oven was heated at a rate of 5° C./minute to 1000° C., and held at this ‘carbonization’ temperature for 1 hour before cooling at a rate of 5° C./minute to room temperature. Once removed, the sample was moderately brittle. Individual filament tensile testing was achieved with 0.5-inch gauge length specimens. The average of 2 filaments resulted in the following means: diameter=11.25 microns; Young's Modulus=37.5 GPa; Tensile Strength=0.36 GPa; Tensile Strain=0.96%.

### Example 3F

The partially sulfonated fiber produce in Example 3B was loaded into a small batch oxidation oven with 20 g weight tension and heated to 230° C. in air at a rate of 5° C./minute. Once at temperature, it was held under these conditions for 5 hours with air flow was maintained at 0.5 L/minute during this oxidation stage. Following this step, the gas flow was changed to 0.5 L/minute of nitrogen and the oven was heated at a rate of 5° C./minute to 1000° C., and held at this ‘carbonization’ temperature for 1 hour before cooling at a rate of 5° C./minute to room temperature. Once removed, the sample was partially fused. Individual filament tensile testing was achieved with both 1-inch and 0.5-inch gauge length specimens. The average of 4 filaments resulted in the following means: diameter=12.4 microns; Young's Modulus=34.8 GPa; Tensile Strength=0.45 GPa; Tensile Strain=1.35%.

### Example 3G

The partially sulfonated fiber produce in Example 3B was loaded into a small batch oxidation oven with 20 g weight tension and heated to 230° C. in air at a rate of 5° C./minute. Once at temperature, it was held under these conditions for 5 hours with air flow was maintained at 0.5 L/minute during this oxidation stage. Following this step, the gas flow was changed to 0.5 L/minute of nitrogen and the oven was heated at a rate of 5° C./minute to 1000° C., and held at this ‘carbonization’ temperature for 1 hour before cooling at a rate of 5° C./minute to room temperature. The sample broke just before carbonization. Once removed, the sample was partially fused. Individual filament tensile testing was achieved with 0.5-inch gauge length specimens. The average of 5 filaments resulted in the following means: diameter=9.88 microns; Young's Modulus=46.4 GPa; Tensile Strength=0.47 GPa; Tensile Strain=1.12%.

### Example 4

Polyethylene fibers characterized as 8.2 microns in diameter, 5.0 g/denier tensile strength, and having 7.5% elongation to break prepared from The Dow Chemical Company's ASPUN™ 6850A copolymer resin of ethylene and 1-octene (melt index=30, density−0.955 g/cm³) are treated with e-beam irradiation with 150 keV AEB instrument operating at 150 keV, under nitrogen, with total exposure of 800 kGy. Following treatment, the sample contains 50% gel content determined by Soxlet extraction. These crosslinked polyethylene fibers are dipped in 10 wt % sulfuric acid, residual acid removed, and then heated in an air convection oven at 115° C. for 15 minutes to provide black fibers showing no sign of filament fusion.

### Example 5

Polyethylene fiber characterized as 9.0 microns in diameter, 2.5 g/denier tensile strength, and having 9.4% elongation to break prepared from The Dow Chemical Company's ASPUN™ 6850A copolymer resin of ethylene and 1-octene (melt index=30, density−0.955 g/cm³) are treated in a 10 wt % sulfuric acid bath and are then passed through a heated tube at 115° C. for 1 hour, and the fibers are observed to be grey in color and displayed no signs of filament fusion.

### Example 6

It is anticipated that the surface sulfonated ASPUN™ 6850 fibers from Example 5 may be treated with e-beam irradiation with a 150 keV AEB instrument operating at 150 keV, under nitrogen, with total exposure of 800 kGy. It is expected that these crosslinked, surface sulfonated polyethylene fibers will show no filament fusion.

### Example 7

A fiber prepared as in example 3A is treated in a 10 wt % sulfuric acid bath and then treated in a heated tube at 110° C. for 1 hour, and the fibers are observed to be grey in color and displayed no signs of filament fusion.

1. A process for producing a surface-treated fabricated article, the process comprising:
(a) providing a polyolefin resin;
(b) converting the polyolefin resin to a fabricated article;
(c) crosslinking at least a portion of the fabricated article; and
(d) modifying the surface of the fabricated article with a sulfuric acid, fuming sulfuric acid, or chlorosulfonic acid-containing solution surface-treating agent to yield the surface-treated fabricated article.

2. The process of claim 1, wherein steps (c) and (d) are performed simultaneously by selecting a surface-treating agent which also crosslinks the fabricated article.

3. The process of claim 1, wherein the surface-treating agent is an SO₃ containing moiety.

4. The process of claim 1, wherein the surface-treating agent is sulfuric acid, fuming sulfuric acid, sulfur trioxide, or chlorosulfonic acid.

5. The process of claim 1, wherein step (d) is performed before step (c).

6. The process of claim 1, wherein step (d) further comprises washing the fabricated article in a solvent.

7. The process of claim 6, wherein the solvent is toluene, xylene, or a high-temperature halocarbon.

8. The process of claim 1, wherein the polyolefin resin includes crosslinkable functional groups, and step (c) comprises crosslinking at least a portion of the crosslinkable functional groups.

9. The process of claim 1, wherein the concentration of the sulfuric acid in the surface-treating agent is 90% or less.

10. A surface-treated fabricated article prepared according to the process of claim 1.

11. The surface treated fabricated article of claim 10, and having a gel content of 40% or greater.

12. The surface treated fabricate article of claim 11 having a char yield of 10% or less.

13. A process for producing a surface-treated fabricated article comprising:
(a) providing a polyolefin resin;
(b) converting the polyolefin resin to a fabricated article;
(c) crosslinking at least a portion of the fabricated article;
(d) applying a sulfuric acid solution to the fabricated article; and
(e) heating the fabricated article in air or an inert environment.

14. The process of claim 13, wherein step (e) is performed at a temperature of from 90° C. to 140° C.

15. The process of claim 13, wherein the inert environment is convective.
